(19) United States
(12) Patent Application Publication
(10) Pub. No.: US 2009/0189362 A1
(43) Pub. Date: Jul. 30, 2009

(54) Carrying case for posters, charts, and graphs

(76) Inventor: Starr DeWitt, Leesburg, FL (US)

Correspondence Address: Charles E. Lykes, Jr., Esq., Suite 101, 501 S. Ft. Harrison Ave., Clearwater, FL, 33756-5348, US

(21) Appl. No.: 12/069,007

(22) Filed: Jan. 24, 2008

(51) Int. Cl. B62B 1/00

(52) U.S. Cl. 280/47.26

(57) ABSTRACT

A box container for transporting charts, graphs, and posters suitable for display in a classroom or small group environment which is adapted with a set of wheels to facilitate movement in either the direction parallel to its width or its breadth. The container may also be, in its interior, adapted with compartments to organize the display and to transport accessories, such as markers, lights, pointers, or notes.

### FIELD OF THE INVENTION

The invention relates to mobile carrying cases for transporting audiovisual aids, posters, charts, or other flat items of that approximate size.

### BACKGROUND OF THE INVENTION

The presentation of educational, informative, or entertaining material is often enhanced by flat, graphic displays such as posters, charts, and printed tables which may be used to illustrate certain aspects of the presentation, present technical or other graphic data, keep an audience focused as to the immediate topic or outlying of presentation, or a myriad of other means and manner in which a plain graphic presentation may be helpful.

Such posters, charts, and other such display items must be large enough to be viewed by a number of people and, as such, are often inconvenient to carry around. It is often desirable to keep them in a flat orientation so that they do not become curled or creased and so that they are easy to present and display. It is also desirable to protect them from the elements and, in many cases, to keep them private until the time of their display. It is also useful to keep them organized. Accordingly, it is useful to have a means and manner of storing and transporting such items also, including other accessories, such as markers and pointers which may be helpful in presenting the display.

Because such devices are often transported through such facilities as schools, hospitals, office buildings, and the like it is also helpful to have such a container which may be easily moved through doorways and narrow hallways. Because of the size of posters and charts it is not unusual that they cannot pass through a door except my positioning the flat poster or chart so that its plane is perpendicular to the plane of the door opening. It can be seen that this is not a matter which can be accomplished whilst keeping the poster flat without some form of container or assistance.

It is also often the case that a number of such display posters and charts are required at the same time and the use of a more durable material coupled with a number of such display posters or charts can become particularly inconvenient to move around because of the heavy weight. Accordingly, it is useful to have some sort of apparatus which may be rolled on wheels or casters to allow movement of heavier displays.

A number of devices for accomplishing similar task have been attempted in the past. For instance, U.S. Pat. Nos. 4,984,685 and 5,103,977 issued to Douglas on Jan. 2, 1990 and Sep. 20, 1990, respectively, teach containers that are useful in storing designated objects such as electric extension cords. They include provisions for wrapping the cord about an axle. While a display board made of a flexible material could be wrapped it is normally undesirable to do so since such would interfere with easily retrieving and presenting the board at a later time. The process of wrapping the board would likely leave a residual curvature to the board and make it difficult to display it on such a conveyance such as an easel or to be hung from a flat surface. It would have to be fastened at all four corners. Moreover, display boards made of an inflexible material such as plywood could not be packaged in such a container at all.

U.S. Pat. No. 6,431,580 issued to Kady on Aug. 13, 2002 and U.S. Pat. No. 5,240,264, issued to Williams, on Jan. 27, 1992, depict containers which are adapted with wheels to facilitate enrolling in mobility went in a tilted position. Both of these inventions may be rolled to transport cargo in only one orientation and neither facilitates the storage of display boards, posters, charts or the like. Both of these inventions recognized the importance of providing mobility conveyances for special purposes.

U.S. Pat. No. 5,823,550, issued to Bennett et al, on Oct. 20, 1998, teaches an apparatus designed for encasing trade show materials. It comprises handles on each end so that two persons may lift it from either end and easily move it. It also comprises a pair of wheels at one of these ends so that a person may lift the handle on the opposite end and pull the apparatus along using the wheels at the opposite end. The apparatus would appear to support movement in only one direction or orientation and does not demonstrate how such things as display boards or posters or charts may be housed within to remain flat.

U.S. Pat. No. 6,935,641, issued to Hahn on Apr. 3, 2003, depicts another container which may be moved along its length by the use of wheels. The device taught by Hahn has been designed for use with toolboxes or other more regular containers or implements and not for display boards, charts, graphs, or the like. It is for bearing weight of more densely constructed objects and not for flat objects.

Accordingly, what is needed but not provided by the prior art is such a mobile container which can be easily moved about either in a variety of orientations so that it may be passed through a door or across its breadth so that it may be more stable and quickly moved across a larger area. What is also not provided in the prior art is an apparatus which will permit such things as display boards, posters, and charts to be easily moved across a variety of surfaces and through passageways in a manner which will also keep such items flat and organized.

### SUMMARY OF THE INVENTION

The inventor has overcome many of the shortcomings of the prior art by having designed a container which is uniquely adapted to store and transport posters, charts, and other larger flat displays so that they will be protected from view and from the elements and so that they may also be moved easily through parking lots, doors, and buildings, including the doorways, gates, and hallways which both divide and connect the facilities to and from parking and storage areas.

The container comprises a boxlike container with a length and width which may be associated with the common sizes of poster or display boards and papers and a depth which is sufficient to contain a number of such display boards. The depth of the container may further be divided into partitions in order to keep individual or small groups of display boards protected and categorized and to enhance their being stored in a flat manner.

In order to make the apparatus both mobile and easy-to-use it has been adapted with a unique bottom which facilitates movement of the box across a floor or other flat surface in either a lengthwise orientation or a breadth orientation as will be more further described in the drawings and specification herewith. This effect is achieved by the positioning of a pair of wheels within recessed portions along one length side and one width side of the bottom of the container in order to achieve stable movement of the apparatus as it is pulled by a handle near the center of the top of the container either along its length or along its breadth.

In order to permit the apparatus to be turned lengthwise to be passed through a doorway or narrow hall, two or more wheels are fil_ along one bottom narrow side of the container within a recessed portion. The container may then be tipped about the axis of a line between these two wheels so that these two wheels comprise the entire interface between the container and the flat surface to be traversed. Then the container may be rolled with some degree of care for a short distance through a doorway or narrow hall.

When the apparatus and its cargo has reached its destination it simply rests upon the floor. The wheels are not in enough contact to permit the container to roll on its own unless it is tilted or tipped in one of the orientations required to facilitate movement. It is unlikely that this would happen accidentally. This leaves plenty of floor contact to achieve stability. As will be more fully described below, the interior cargo area of the conveyance may be compartmentalized for organization of the display materials and a tray could be provided in order to store accessories in a accessible manner.

It is, then, an object of the present invention to provide a container for display boards which will permit such display boards to be stored and maintained in a flat position or orientation and which will further permit them to be moved by the use of wheels or casters across flat surfaces such as parking lots and floors.

It is a further object of the present invention to provide such a container which will further facilitate the organization and easy retrieval of such display boards from within.

It is a further object of the present invention to provide such a container which will further permit such display boards to be moved through a variety of facilities in a safe and efficient manner.

It is a further object of the present invention to provide such a mobile container for display and poster boards which will further permit them to be reliably and with stability located in a desired location.

It is a further object of the present invention to provide such a conveyance which may be rolled and steered either along its length or along its breadth.

It is a further object of the present invention to provide such a conveyance which will store accessories, such as markers, pointers, pens, and notepads along with the display materials and easily accessible to them.

It is a further object of the present invention to provide such a conveyance with wheels or casters which are mounted directly to the bottom near one wide side and one narrow side of a flat box and adapted with aprons in order to achieve stability when at rest.

Other features and advantages of the present invention will be apparent from the following description in which the preferred embodiments have been set forth in conjunction with the accompanying drawings.

### BRIEF DESCRIPTION OF THE DRAWINGS

In describing the preferred embodiments of the invention reference will be made to the series of figures and drawings briefly described below.

FIG. 1 depicts the over all apparatus from the front.

FIG. 2 depicts the apparatus from one end in which two wheels are mounted for the purpose of facilitating rolling through a door or narrow passageway.

FIG. 3 depicts the apparatus from the back side and enables viewing of how the wheels may be oriented in order to facilitate easy movement across an area which is relatively free of obstructions.

FIG. 4 depicts the apparatus from below where the positioning of the wheels can be more easily seen.

FIG. 5 depicts the apparatus in position to be moved through a doorway or other narrow passage.

FIG. 6 depicts how the apparatus may be configured for compartmentalized storage of display boards.

FIG. 7 depicts how handles may be positioned in order to facilitate moving the device through a doorway or other narrow passageway.

FIG. 8 depicts an alternative structure in which the wheels are mounted directly to the flat bottom of such a container and aprons around the opposite sides are used to achieve stability and to protect the wheels from contact with the ground except when desired.

While certain drawings have been provided in order to teach the principles and operation of the present invention, it should be understood that, in the detailed description which follows, reference may be made to components or apparatus which are not included in the drawings. Such components and apparatus should be considered as part of the description, even if not included in such a drawing. Likewise, the drawings may include an element, structure, or mechanism which is not described in the textual description of the invention which follows. The invention and description should also be understood to include such a mechanism, component, or element which is depicted in the drawing but not specifically described.

### DETAILED DESCRIPTION OF THE PREFERRED EMBODIMENT

Reference will now be made in detail to the present preferred embodiment of the invention, an example of which is illustrated in the accompanying drawings. While the invention will be described in connection with a preferred embodiment, it will be understood that it is not intended to limit the invention to that embodiment. On the contrary, it is intended to cover all alternatives, modifications, and equivalents as may be included within the spirit and scope of the invention defined in the appended claims.

While the following description will seek to improve understanding of the invention by describing the various components and elements, it should be considered that certain apparatus may be sufficiently and adequately explained by the accompanying drawings, which are fully incorporated herein, and not require further description. All such apparatus should be considered as part of the specification of the invention for all purposes.

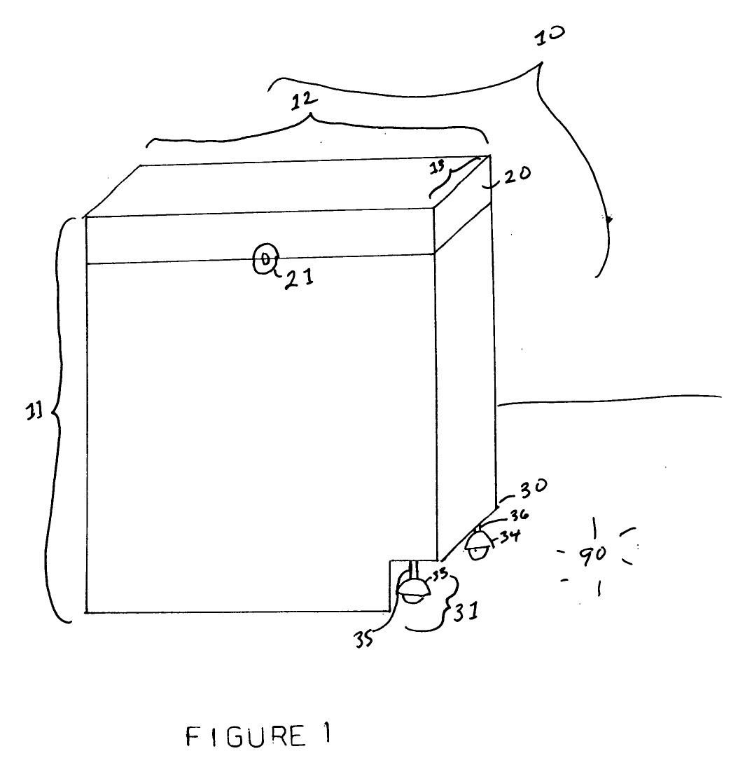

Making reference first to FIG. 1 it can be seen that the container (10) according to the present invention has a length (11) and width (12) which are much greater than its depth (13). The dimensions of the length (11) and width (12) may be selected so as to be greater than, in both of these dimensions, typical display and poster boards which are frequently used for classroom presentations, small groups, or in such things as science projects and informational seminars, or special purpose lectures. It can also be seen that the container (10) may be adapted with a lid (20) which is further adapted with a latch (21). FIG. 1 further depicts that at one end (30) of the apparatus (10) there is a cutaway region (31) in which two wheels (33, 34) are positioned and mounted so that they extend from the top of the cut away portion (31) on mounts (35, 36) so that the wheels (33, 34) come very close to, but do not fully engage with a flat surface (90) upon which the container (10) may be resting. The cutaway region (31) is only large enough to facilitate the positioning of the wheels and not to interfere with the interior storage of the apparatus.

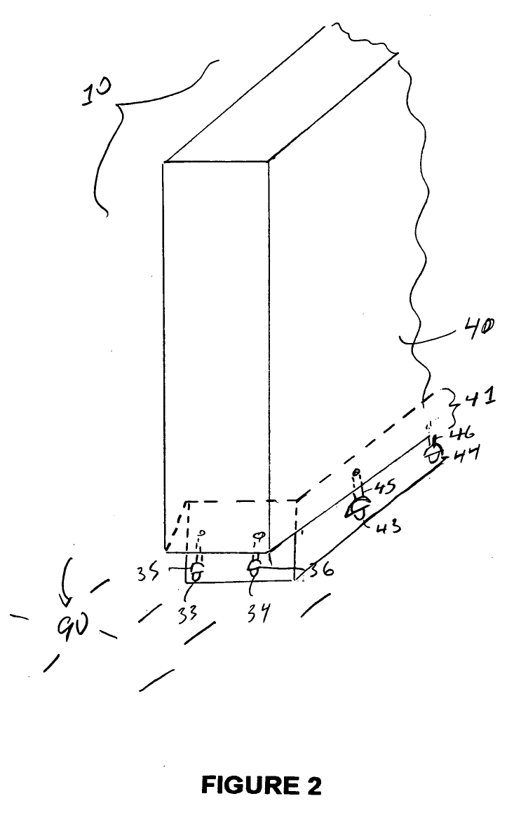

Making reference now to FIG. 2, which depicts the container (10) viewed from the end of the container (10) which houses the cutaway portion (31) and the two wheels (33, 34). It can now be seen that the back side (40) of the apparatus (10) also is adapted with a separate cutaway portion (41) from which, in a similar manner to the narrow end (30) of the container (10) is also further adapted with two or more wheels (43, 44) which are also mounted so that they extend from the top of the cut away portion (41) on mounts (45), 46 so that the wheels (43, 44) come very close to, but do not fully engage with a flat surface (90) upon which the container (10) may be resting. As with the narrow end cutaway portion (31) the back side cutaway portion (41) is only large enough to house the wheels and does not interfere with the storage of the apparatus.

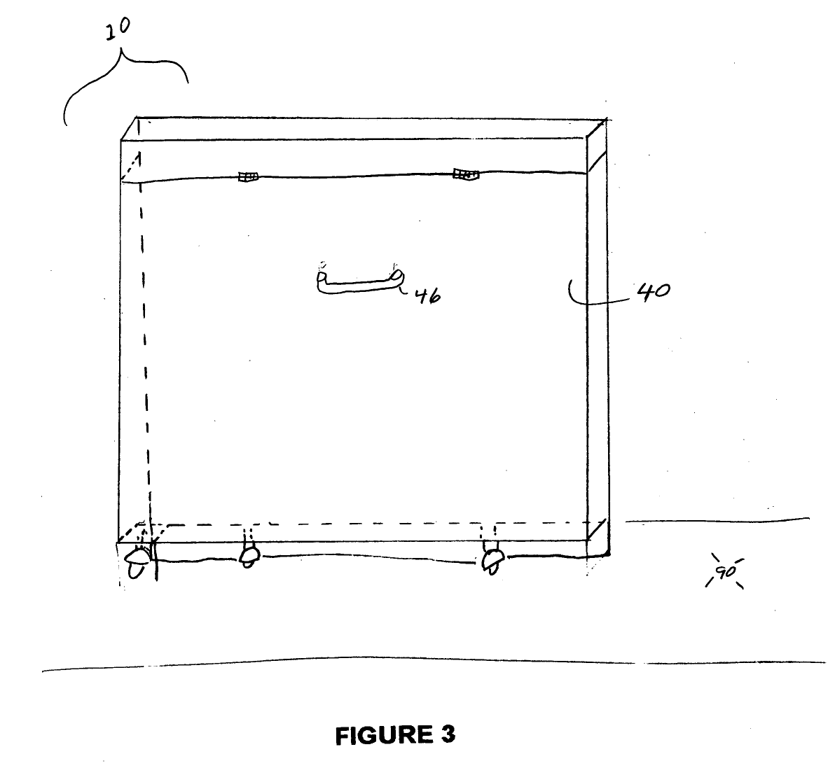

FIG. 3 depicts the container (10) from the backside (40). It can be seen that the backside (40) is further adapted with a handle (46) which can be used to tilt the apparatus backwards so that contact between the container (10) and the flat surface (90) is made only with the rear wheels (43, 44) and the apparatus (10) can be pulled a long by the handle (46) very easily.

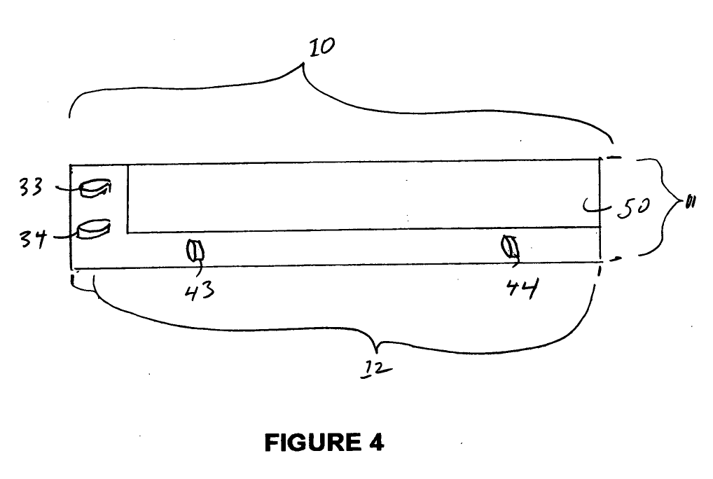

FIG. 4 depicts the container (10) from the bottom side (50). From this perspective the positioning of the end cut away portion (31) and the wheels (33, 34) and the back cutaway portion (41) and the wheels (43, 44) can be more readily seen. It can now be understood how the apparatus can be easily moved in either the direction (61) corresponding with its width (12) or in the direction (62) corresponding with its breadth (11).

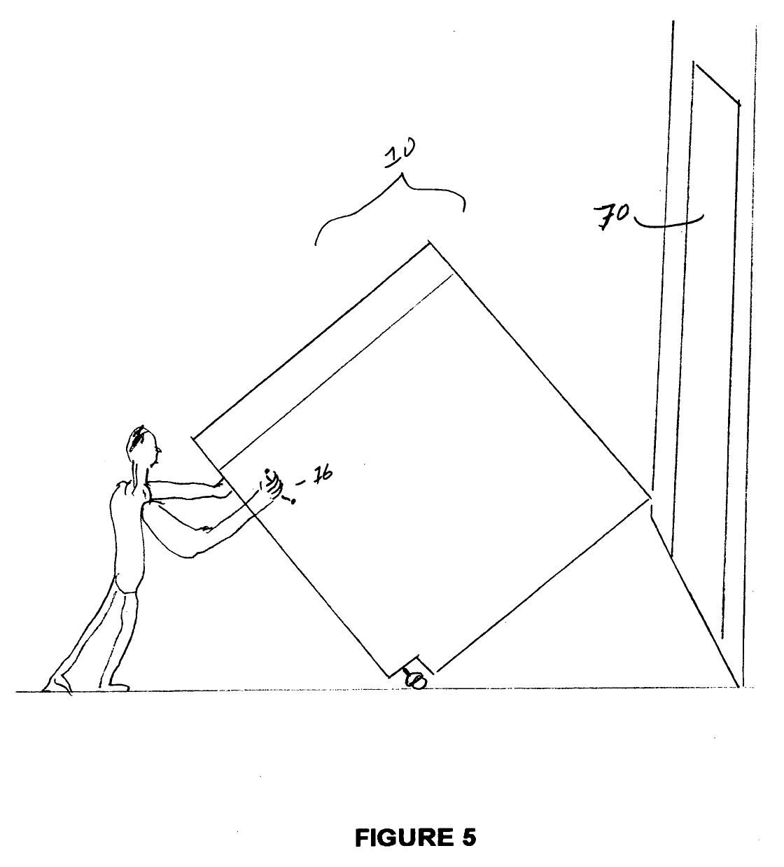

FIG. 5 depicts the container (10) as it is tilted to be moved through a doorway (70) or other narrow passage, such as a hallway (not depicted), FIG. 5 also depicts how handles (16, 17) may be provided on the front side (15) and backside (not depicted) in order to facilitate easy movement and positioning of the container (10) into the desired tilt condition.

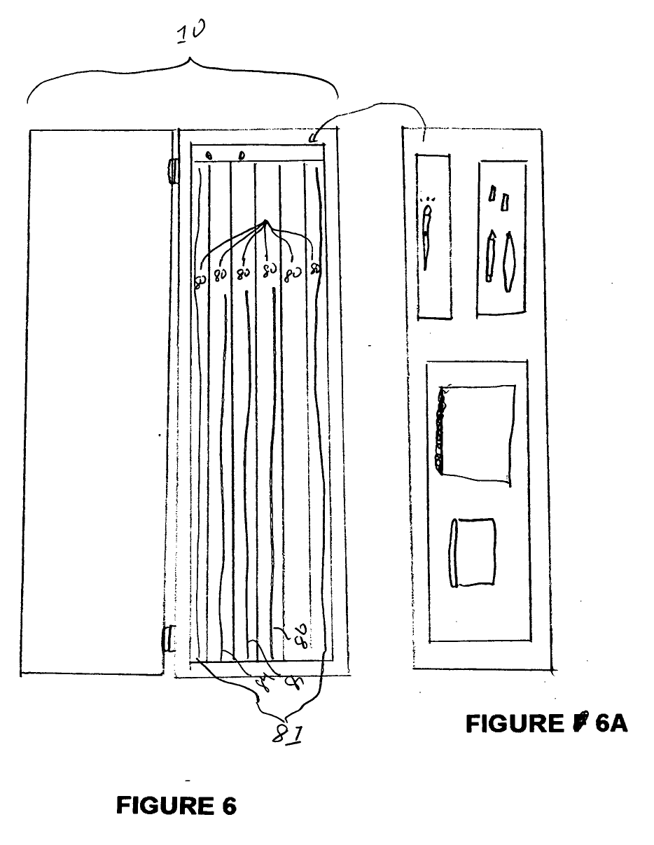

FIG. 6 is a view from the top of the container (10) in which it can be seen that the interior of the container (10) may be divided into a series of compartments (80) within each of which one or more display boards (81) may be kept together and separated from one or more other display boards (82) in other compartments (84,85,86). It can also be seen that all of the display boards (81, 82) will be stored in a generally spread out and upright condition regardless of the orientation of the container (10). In this manner the various display boards (81, 82) are protected from inadvertent view, kept organized, and are kept in a generally flat orientation so that they will display properly and easily.

FIG. 6A depicts how the container (10) may be further adapted with an upper tray or storage area (87) which may be used to store other small implements such as markers, pointers, laser pointers, pens, notepads, or other implements (141, 142, 143, 144, 145) useful in assisting in such a presentation.

Having described the preferred embodiment of the present invention it is important to note that a variety of alternatives and options are available in keeping within the spirit and scope of the present invention. For instance, the apparatus has been described using two end wheels (33, 34) and 2 rear wheels (43, 44). It can be easily seen that at least two wheels must be used in each of these locations but that there is no reason that three or more wheels could be used for increased stability and ease of use. This would particularly be the case across the backside (40) of the apparatus which is much wider and may require additional support.

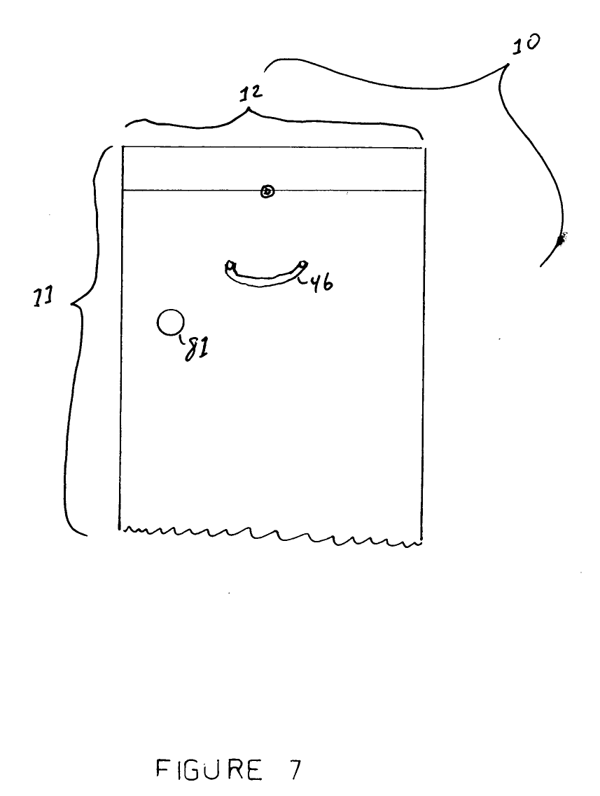

Certain positioning of the handles and has been described but in reality the apparatus could function with only a single handle on the top or with any combination of one or more handles which may be desired. It should be noted, however, that various handle orientations may be desirable in order to facilitate ease of tilting, pushing, and steering the apparatus. For instance, when transporting the apparatus through a door, it will normally be desirable to have two handles, oppositely positioned on the front and back sides of the apparatus (10) because the apparatus will be less stable when moved in the orientation. This will also require the use of both hands so that any other case or container (such as a briefcase handbag) without a shoulder strap would need to be set down. FIG. 7 depicts a rear handle (46) as has been previously described, and a knob handle (81) which, together with an opposite knob handle (not depicted) could be used to move the box sideways. When transporting along the width, however, the apparatus would be sufficiently stable to allow it to be pulled from a single handle or strap and a briefcase could be carried along.

The essential features of the invention comprise the unique combination of wheels which permit the apparatus to easily rest on its bottom in a stable manner but, when desired, to be tilted in either a lengthwise direction or across its breadth and easily handled for mobility from a flat parking lot to a desired room as long as there is always a flat surface available for rolling. They also permit display material to preserved, protected, and organized, and useful accessories to be stored and transported along with ease and convenience.

The preferred embodiment of the present invention has been described with respect to a generally flat bottom which rests upon the flat surface but is adapted with two portions cut away to accommodate the wheels oriented in either direction of movement. It should also be noted that the principles of the present invention could also be accomplished with providing a box with two supporting aprons which extend below the bottom of the box a sufficient distance to accommodate the wheels. Such an apron would be extending from one entire width of the container and one entire width of the container so that the wheels would be free to make contact with the flat surface or floor to be navigated.

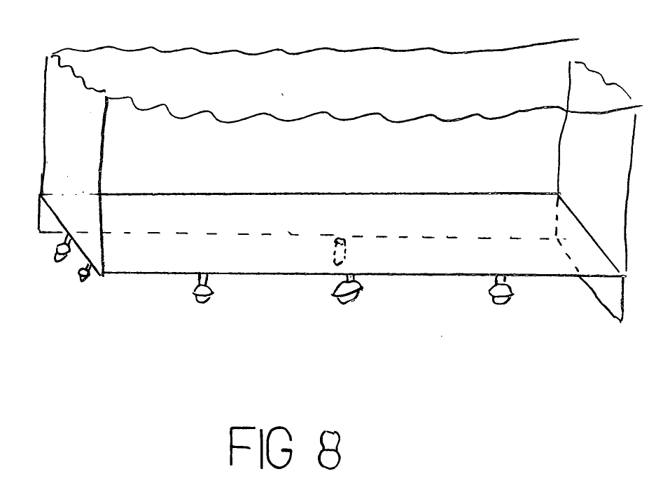

A depiction of the bottom of a container according to this variation is attached hereto as FIG. 8. It should be noted that, in order to ensure the stability of the apparatus at rest, some form of support is provided from the bottom of the container near its center (152). Since the apron (151) can't only extend from two sides and since one of the sides must be its length and one of the sides must be its width, the apparatus could tilt or tump over if some other form of support were not provided. Some form of support near the center of the bottom of the box would serve to provide such stability and still permit the container to be tilted in either orientation for movement over a flat surface as envisioned.

It should also be noted that if the distance of extension of the apron members (151) was equal to the length of the wheel apparatus than no other support would be required because the aprons and wheels would all rest upon the ground together and would support the box bottom with adequate stability.

Further modification and variation can be made to the disclosed embodiments without departing from the subject and spirit of the invention as defined in the following claims. All such modifications and variations, as included within the scope of these claims, are meant to be considered part of the invention as described.

What is claimed is:

1. A mobile container for moving display boards, posters, charts, or other similar items by one person across a variety of flat surfaces and areas, the container further comprising:
a box container with a generally rectangular cross section further comprising a length, width, and height sufficient to permit a standard display board, poster, or chart (hereinafter said display items) to be laid flat within, said enclosure further comprising at least one open side to permit such display items to be easily placed within and removed from said container, and a depth sufficient to permit a number of such display items to be stacked upon one another in a flat orientation;
said container further being adapted with one set of wheels mounted within a cut away portion at the bottom of one end of said container to facilitate movement in a direction perpendicular to its width, said mounted wheels further comprising two or more mounting members from the top surface of said cut away portion so that two or more wheels may be mounted upon said mounting members so that they will extend almost, but not quite, a length corresponding to the distance from the top surface of said cut away portion to the bottom of said container, said mounted wheels further being positioned close enough to both the front and back sides of said container so that the container may be tilted up upon said wheels and reliably rolled in the direction corresponding with its width;
said container further being adapted with one set of two or more wheels mounted within a cut away portion along the bottom of one long side of said container in order to facilitate movement in a direction corresponding with its depth, said mounted wheels further comprising two or more mounting members from the top surface of said cut away portion so that two or more wheels may be mounted upon said mounting members so that they will extend almost, but not quite, a length corresponding to the distance from the top surface of said cut away portion to the bottom of said container, said mounted wheels further being positioned close enough to both the left and right sides of said container so that the container may be tilted up upon said wheels and reliably rolled in the direction corresponding with its depth;
said container been further adapted with one or more handles to facilitate the tilting and pulling of said container in the desired orientation.

2. The mobile container described in claim 1 which is further adapted for compartmentalized storage of display boards, charts, graphs, and similar items with one or more partitioning members within the interior of said container which further divide the interior of said container into two or more sections across its depth so that display boards, charge, or graphs or similar items may be divided into two or more groupings or easy retrieval and placement for storage.

3. The mobile container described in claim 1 which is further adapted for the storage of other useful implements in display presentation, including but not limited to pens, markers, pointers, laser pointers, notes, fasteners, thumbtacks, clips, or any one of a variety of small fattening, marking, and pointing implements, the adaptation further comprising one or more containers which may be placed and fastened across the top or open and of said mobile container.

4. The mobile container described in claim 1 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

5. The mobile container described in claim 2 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

6. The mobile container described in claim 3 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

7. A mobile container for moving display boards, posters, charts, or other similar items by one person across a variety of flat surfaces and areas, the container further comprising:
a box container with a rectangular cross section further comprising a length, width, and height sufficient to permit a standard display board, poster, or chart (hereinafter said display items) to be laid flat within, said enclosure further comprising at least one open side to permit such display items to be easily placed within and removed from said container, and a depth sufficient to permit a number of such display items to be stacked upon one another in a flat orientation;
said container further being adapted with one set of wheels mounted at the bottom of one end of said container to facilitate movement in a direction perpendicular to its width, said mounted wheels further comprising two or more mounting members from the surface of said container bottom so that two or more wheels may be mounted upon said mounting members so that they will extend almost, but not quite, a length from the distance from the bottom surface of said container, said mounted wheels further being positioned close enough to both the front and back sides of said container so that the container may be tilted up upon said wheels and reliably rolled in the direction corresponding with its width;
said container further being adapted with one set of two or more wheels mounted along the bottom of one long side of said container in order to facilitate movement in a direction corresponding with its depth, said mounted wheels further comprising two or more mounting members from the bottom surface of said cut away portion so that two or more wheels may be mounted upon said mounting members so that they will extend almost, but not quite, a length from the bottom of said container, said mounted wheels further being positioned close enough to both the left and right sides of said container so that the container may be tilted up upon said wheels and reliably rolled in the direction corresponding with its depth;
said container being further adapted with an apron along the opposite long side of the container bottom, said long side apron extending a distance below the box bottom equal to or slightly more than the length of the long side wheel apparatus and being also adapted with an apron along the opposite narrow bottom side of said container, said paper and extending below the bottom of the box a distance equal to or slightly greater than the length of the narrow side wheel apparatus;
said container being further adapted with one or more handles to facilitate the tilting and pulling of said container in the desired orientation.

8. The mobile container described in claim 7 which is further adapted for compartmentalized storage of display boards, charts, graphs, and similar items with one or more partitioning members within the interior of said container which further divide the interior of said container into two or more sections across its depth so that display boards, charge, or graphs or similar items may be divided into two or more groupings or easy retrieval and placement for storage.

9. The mobile container described in claim 7 which is further adapted for the storage of other useful implements in display presentation, including but not limited to pens, markers, pointers, laser pointers, notes, fasteners, thumbtacks, clips, or any one of a variety of small fattening, marking, and pointing implements, the adaptation further comprising one or more containers which may be placed and fastened across the top or open and of said mobile container.

10. The mobile container described in claim 7 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

11. The mobile container described in claim 8 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

12. The mobile container described in claim 9 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

13. A mobile container for moving display boards, posters, charts, or other similar items by one person across a variety of flat surfaces and areas, the container further comprising:
a box container with a rectangular cross section further comprising a length, width, and height sufficient to permit a standard display board, poster, or chart (hereinafter said display items) to be laid flat within, said enclosure further comprising at least one open side to permit such display items to be easily placed within and removed from said container, and a depth sufficient to permit a number of such display items to be stacked upon one another in a flat orientation, said box container further adapted to rest stably on a bottom side;
said box container being adapted to be rolled while oriented either along its width or its breadth by means of one set of two or more wheels aligned along one of its wide bottom sides so that the box container, when tilted about said bottom wide side, will be supported by said wide bottom side wheels to permit it to be easily rolled in the direction perpendicular to said wide side, said box container further being adapted with a set of two or more wheels along one narrow bottom side so that the box container, when tilted about said narrow bottom side, will be supported by said wide bottom side wheels to permit it to be easily rolled in the direction perpendicular to said narrow side,
said container being further adapted with one or more handles to facilitate the tilting and pulling of said container in the desired orientation.

14. The mobile container described in claim 13 which is further adapted for compartmentalized storage of display boards, charts, graphs, and similar items with one or more partitioning members within the interior of said container which further divide the interior of said container into two or more sections across its depth so that display boards, charge, or graphs or similar items may be divided into two or more groupings or easy retrieval and placement for storage.

15. The mobile container described in claim 13 which is further adapted for the storage of other useful implements in display presentation, including but not limited to pens, markers, pointers, laser pointers, notes, fasteners, thumbtacks, clips, or any one of a variety of small fattening, marking, and pointing implements, the adaptation further comprising one or more containers which may be placed and fastened across the top or open and of said mobile container.

16. The mobile container described in claim 13 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

17. The mobile container described in claim 14 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.

18. The mobile container described in claim 15 which is further adapted for ease of handling with handles which are oppositely disposed and near the top of said container on the end of said container which houses said set of wheels facilitating movement in a direction along its length so that a person may grasp each of said handles together and tilt the apparatus for movement and then move the apparatus either forward or backward along its length in a stable and simple manner.
